(19) United States
(12) Patent Application Publication
(10) Pub. No.: US 2017/0197843 A1
(43) Pub. Date: Jul. 13, 2017

(54) METAL COMPOSITE OXIDE PARTICLES AND METHOD FOR PRODUCING SAME

(71) Applicant: NISSHIN ENGINEERING INC., Tokyo (JP)

(72) Inventor: Akihiro KINOSHITA, Fujimino-city, Saitama (JP)

(21) Appl. No.: 15/315,644

(22) PCT Filed: Mar. 31, 2015
(86) PCT No.: PCT/JP2015/060082

§ 371 Date: Dec. 1, 2016

(30) Foreign Application Priority Data
Jun. 5, 2014 (JP) 2014-116779

(51) Int. Cl. C01G 3/00; H05H 1/28

(52) U.S. Cl. CPC C01G 3/006; H05H 1/28; C01P 2004/64; C01P 2006/60; C01P 2006/40

(57) ABSTRACT

The metal complex oxide particles according to the present invention are represented by general formula MCu₂O₂ and include copper. M is at least one of the alkaline earth metals Sr and Ba, and the metal complex oxide particles have a particle size of 1 to 100 nm and are transparent. M may further include at least one of the alkaline earth metals Mg and Ca. These metal complex oxide particles are granular p-type inorganic oxide semiconductor particles which are transparent and have a narrow particle size distribution and a uniform particle size, with there being few coarse particles of 1 μm or greater. In addition, a method for producing the metal complex oxide particles according to the present invention can easily and reliably produce transparent granular metal complex oxide particles.

### TECHNICAL FIELD

The present invention relates to copper-containing metal complex oxide fine particles expressed by a general formula MCu₂O₂ (where M is at least one of Sr and Ba) which are obtainable by using a thermal plasma flame as well as a method of producing the same, particularly to a method of producing metal complex oxide fine particles that enables particulate metal complex oxide fine particles having transparency to be easily and reliably produced.

### BACKGROUND ART

At present, various types of fine particles are used in various applications. For instance, fine particles such as metal fine particles, oxide fine particles, nitride fine particles and carbide fine particles have been used in semiconductor substrates, printed circuit boards, electrical insulation materials for various electrical insulation parts and the like, cutting tools, dies, materials for high-hardness and high-precision machining tools such as bearings, grain boundary capacitors, functional materials for humidity sensors and the like, the production of sintered bodies for use as precision sinter molding materials and the like, the production of thermal sprayed parts such as engine valves made of materials that are required to be wear-resistant at high temperatures, electrodes of fuel cells, electrolyte materials, and various catalyst field, as well as in the semiconductor field.)

As a product using such fine particles, for instance, an oxide semiconductor electrode composed of a p-type inorganic oxide semiconductor having a particle size of 0.1 nm to 1000 nm and containing one of Cu, Al, Ag, Ni, Co, In, Fe, Zn, Rh, Ga, Sr, Li and N, with a part of the p-type inorganic oxide semiconductor having a fiber structure, is described by Patent Literature 1. The p-type inorganic oxide semiconductor electrode of Patent Literature 1 is produced by a precipitation process or a sol-gel process.

### CITATION LIST

### Patent Literature

Patent Literature 1: JP 2006-66215 A

### SUMMARY OF INVENTION

### Technical Problems

Patent Literature 1 describes that the p-type inorganic oxide semiconductor electrode is produced by the precipitation process or the sol-gel process and a part of the electrode has a fiber structure. However, Patent Literature 1 discloses neither p-type inorganic oxide semiconductor particles in a dispersible state nor a specific method of producing p-type inorganic oxide semiconductor particles in a dispersible state. Besides, Patent Literature 1 mentions CuO, Cu₂O, CuGaO₂, ZnRh₂O₄, NiO, CoO, CuAlO₂, SrCu₂O₂, CuO:Li, Cu₂O:Li, CuO:Li, ZnO:In:N and ZnO:Be:N as p-type inorganic oxide semiconductors. Those p-type inorganic oxide semiconductors include semiconductors having no transparency such as CuO, NiO and CoO. At present, there are no particulate p-type inorganic oxide semiconductor particles having transparency.

An object of the present invention is to solve the above problem inherent in the prior art and to provide metal complex oxide fine particles that are fine particles of particulate p-type inorganic oxide semiconductor having transparency, having a narrow particle size distribution, i.e., a uniform particle size, and hardly including coarse particles having a particle size of 1 μm or more, as well as a method of producing metal complex oxide fine particles that enables such metal complex oxide fine particles to be easily and reliably produced.

### Solution to Problems

In order to attain the foregoing objects, the present invention provides metal complex oxide fine particles containing copper as represented by a general formula MCu₂O₂, wherein M in the general formula is, of Sr and Ba, at least one alkaline earth metal, the metal complex oxide fine particles having a particle size of 1 to 100 nm and having transparency. In the above, M in the general formula may further include, of Mg and Ca, at least one Group 2 element.

The present invention provides a method of producing metal complex oxide fine particles, comprising: a pretreatment step of pretreating copper compound powder and alkaline earth metal compound powder containing, of Sr and Ba, at least one alkaline earth metal; and a formation step of forming particulate metal complex oxide fine particles having transparency from the copper compound powder and alkaline earth metal compound powder as pretreated, using a thermal plasma flame, wherein the thermal plasma flame is derived from an inert gas.

In the above, preferably, the pretreatment step includes a step of dispersing the copper compound powder and the alkaline earth metal compound powder using a carrier gas, and the formation step includes a step of supplying the copper compound powder and the alkaline earth metal compound powder as dispersed, into the thermal plasma flame.

In the above, preferably, the pretreatment step includes a step of dispersing the copper compound powder and the alkaline earth metal compound powder in water to obtain a slurry, and the formation step includes a step of converting the slurry into droplets to supply the droplets into the thermal plasma flame.

For example, the inert gas is at least one selected from helium gas, argon gas and nitrogen gas.

The alkaline earth metal compound powder may further include a compound containing, of Mg and Ca, at least one Group 2 element.

### Advantageous Effects of Invention

The present invention is capable of providing metal complex oxide fine particles that are fine particles of particulate p-type inorganic oxide semiconductor having transparency, having a narrow particle size distribution, i.e., a uniform particle size, and hardly including coarse particles having a particle size of 1 μm or more.

In addition, the present invention enables easy and reliable production of particulate metal complex oxide fine particles having transparency.

### BRIEF DESCRIPTION OF DRAWINGS

FIG. 1 is a schematic view showing a fine particle production apparatus that is used in a method of producing metal complex oxide fine particles according to an embodiment of the invention.

FIG. 2 is a graph showing analysis results of metal complex oxide fine particles as obtained by X-ray diffractometry.

FIG. 3 is a photograph as a substitute of a drawing for showing metal complex oxide fine particles.

FIG. 4 is a graph showing analysis results of metal complex oxide fine particles as obtained by X-ray diffractometry.

FIG. 5 is a graph showing analysis results of metal complex oxide fine particles as obtained by X-ray diffractometry.

FIG. 6 is a graph showing analysis results of metal complex oxide fine particles with different compositional ratios as obtained by X-ray diffractometry.

FIG. 7 is a graph showing analysis results of metal complex oxide fine particles with different compositional ratios as obtained by X-ray diffractometry.

FIG. 8 is an enlarged view showing a main part of FIG. 7.

FIG. 9 is a graph showing optical characteristics of metal complex oxide fine particles.

### DESCRIPTION OF EMBODIMENTS

On the following pages, metal complex oxide fine particles and a method of producing the same according to the invention are described in detail with reference to preferred embodiments shown in the accompanying drawings.

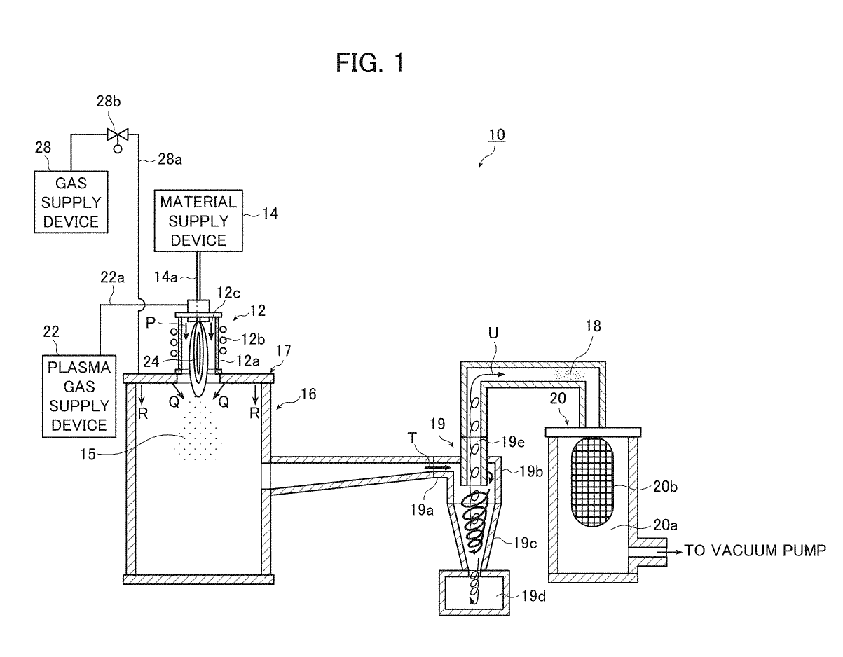

FIG. 1 is a schematic view showing a fine particle production apparatus that is used in the method of producing metal complex oxide fine particles according to an embodiment of the invention.

A fine particle production apparatus (hereinafter referred to simply as “production apparatus”) 10 shown in FIG. 1 is used to produce metal complex oxide fine particles.

The production apparatus 10 includes a plasma torch 12 generating thermal plasma, a material supply device 14 supplying a material for producing metal complex oxide fine particles into the plasma torch 12, a chamber 16 serving as a cooling tank for producing primary fine particles 15 of metal complex oxide fine particles, a cyclone 19 removing, from the produced primary fine particles 15 of metal complex oxide fine particles, coarse particles having a particle size equal to or larger than an arbitrarily specified particle size, and a collecting section 20 collecting secondary fine particles 18 of metal complex oxide fine particles having a desired particle size as obtained by classification in the cyclone 19. Various devices described in, for example, JP 2007-138287 A may be used for the material supply device 14, the chamber 16, the cyclone 19 and the collecting section 20.

In this embodiment, the production of metal complex oxide fine particles uses copper compound powder and alkaline earth metal compound powder containing, of Sr and Ba, at least one alkaline earth metal.

The average particle size of the copper compound powder is appropriately set so as to readily evaporate in a thermal plasma flame and is, for example, up to 100 μm, preferably up to 10 μm and even more preferably up to 3 μm. Examples of the copper compound powder that may be used include cupric oxide (CuO) powder, cupric hydroxide (Cu(OH)₂) powder, cupric sulfate (CuSO₄) powder, cupric nitrate (Cu(NO₃)₂) powder and copper peroxide (Cu₂O₃, CuO₂, CuO₃) powder.

Examples of the alkaline earth metal compound powder containing, of Sr and Ba, at least one alkaline earth metal include strontium carbonate (SrCO₃) powder and barium carbonate (BaCO₃) powder.

The alkaline earth metal compound powder may further include a compound containing, of Mg and Ca, at least one Group 2 element. More specifically, magnesium carbonate (MgCO₃) or calcium carbonate (CaCO₃) may be contained.

In the following description, the term “alkaline earth metal compound” refers to a compound containing, of Sr and Ba, at least one alkaline earth metal or refers to a compound containing, of Mg and Ca, at least one Group 2 element in addition to such a compound containing the above alkaline earth metal(s).

The average particle size of the alkaline earth metal compound powder is, for example, up to 100 μm, preferably up to 10 μm and even more preferably up to 3 μm. The average particle size of the alkaline earth metal compound powder may be measured using the BET method.

The plasma torch 12 includes a quartz tube 12a and a coil 12b for high frequency oscillation surrounding the outside of the quartz tube. On top of the plasma torch 12, a supply tube 14a which is for supplying copper compound powder and the above-described alkaline earth metal compound powder into the plasma torch 12 in the form of powder or slurry is provided at the central portion thereof. A plasma gas supply port 12c is formed in the peripheral portion of the supply tube 14a (on the same circumference). The plasma gas supply port 12c is in a ring shape.

A plasma gas supply device 22 is configured to supply plasma gas into the plasma torch 12. The plasma gas supply device 22 has a gas supply section (not shown), which is connected to the plasma gas supply port 12c through pipe 22a. The gas supply section is provided with a supply amount adjuster (not shown) such as a valve for adjusting the supply amount.

Plasma gas is supplied from the plasma gas supply device 22 into the plasma torch 12 through the plasma gas supply port 12c. An inert gas is used as the plasma gas. For example, at least one gas selected from helium gas, argon gas and nitrogen gas is used as the inert gas.

For instance, at least one gas selected from, for example, helium gas, argon gas and nitrogen gas is stored in the gas supply section. At least one gas selected from helium gas, argon gas and nitrogen gas is supplied as the plasma gas from the gas supply section of the plasma gas supply device 22 into the plasma torch 12 in a direction indicated by arrow P after having passed through the ring-shaped plasma gas supply port 12c via the pipe 22a. Then, a high frequency voltage is applied to the coil 12b for high frequency oscillation to generate a thermal plasma flame 24 in the plasma torch 12.

Plasma gas should be at least one gas selected from helium gas, argon gas and nitrogen gas. The invention is not limited to a case where any of these gases is used alone but these may be used in combination. For example, the combination of argon gas and nitrogen gas may be used as plasma gas.

It is necessary for the thermal plasma flame 24 to have a higher temperature than the boiling points of copper compound powder and the above-described alkaline earth metal compound powder. The thermal plasma flame 24 preferably has a higher temperature because the copper compound powder and the alkaline earth metal compound powder are more easily converted into a gas phase state. However, there is no particular limitation on the temperature. For instance, the thermal plasma flame 24 may have a temperature of 6,000° C., and in theory, the temperature is deemed to reach around 10,000° C.

The ambient pressure inside the plasma torch 12 is preferably up to atmospheric pressure. The ambient pressure of up to atmospheric pressure is not particularly limited and is, for example, in a range of 0.5 to 100 kPa.

The outside of the quartz tube 12a is surrounded by a concentrically formed tube (not shown), and cooling water is circulated between this tube and the quartz tube 12a to cool the quartz tube 12a with the water, thereby preventing the quartz tube 12a from having an excessively high temperature due to the thermal plasma flame 24 generated in the plasma torch 12.

The material supply device 14 is connected to the upper portion of the plasma torch 12 through the supply tube 14a. For the material supply device 14, use may be made of, for example, two systems including one which supplies copper compound powder and alkaline earth metal compound powder in the form of powder and the other which supplies copper compound powder and alkaline earth metal compound powder in the form of slurry containing them.

For example, the device disclosed in JP 2007-138287 A may be used as the material supply device 14 which supplies copper compound powder and alkaline earth metal compound powder in the form of powder. In this case, the material supply device 14 includes, for example, a storage tank (not shown) storing copper compound powder and alkaline earth metal compound powder, a screw feeder (not shown) transporting the copper compound powder and the alkaline earth metal compound powder in fixed amounts, a dispersion section (not shown) dispersing the copper compound powder and the alkaline earth metal compound powder to convert them into the state of primary particles before the copper compound powder and the alkaline earth metal compound powder are finally diffused, and a carrier gas supply source (not shown).

Together with a carrier gas from the carrier gas supply source to which a push-out pressure is applied, the copper compound powder and the alkaline earth metal compound powder are supplied into the thermal plasma flame 24 in the plasma torch 12 through the supply tube 14a.

The configuration of the material supply device 14 is not particularly limited as long as the device prevents the copper compound powder and the alkaline earth metal compound powder from agglomerating, thus making it possible to diffuse the copper compound powder and the alkaline earth metal compound powder in the plasma torch 12 with the dispersed state maintained. As with the above-described plasma gas, for example, an inert gas is used as the carrier gas. The flow rate of the carrier gas can be controlled with a float type flowmeter. The flow rate value of the carrier gas indicates a reading on the flowmeter.

For example, the device disclosed in JP 2011-213524 A may be used as the material supply device 14 which supplies copper compound powder in the form of slurry. In this case, the material supply device 14 includes a vessel (not shown) for introducing a slurry (not shown), an agitator (not shown) agitating the slurry in the vessel, a pump (not shown) for supplying the slurry into the plasma torch 12 through the supply tube 14a with a high pressure applied thereto, and an atomization gas supply source (not shown) which supplies atomization gas for supplying the slurry into the plasma torch 12 in the form of droplets. The atomization gas supply source corresponds to the carrier gas supply source. The atomization gas is also called carrier gas.

In the case where copper compound powder and alkaline earth metal compound powder are supplied in the form of slurry in the embodiment, the copper compound powder and the alkaline earth metal compound powder are dispersed in water to obtain a slurry, which is used to produce metal complex oxide fine particles.

The mixing ratio of copper compound powder and alkaline earth metal compound powder to water in the slurry is not particularly limited and is, for example, 5:5 (50%:50%) in terms of weight ratio.

In the case where the material supply device 14 supplying copper compound powder and alkaline earth metal compound powder in the form of slurry is used, atomization gas from the atomization gas supply source to which a push-out pressure is applied is supplied together with the slurry into the thermal plasma flame 24 in the plasma torch 12 through the supply tube 14a. The supply tube 14a has a two-fluid nozzle mechanism for spraying the slurry into the thermal plasma flame 24 in the plasma torch and converting it into droplets, whereby the slurry can be sprayed into the thermal plasma flame 24 in the plasma torch 12, in other words, the slurry can be converted into droplets. As with the carrier gas, for example, as with the above-described plasma gas, an inert gas is used for the atomization gas.

As described above, the two-fluid nozzle mechanism is capable of applying a high pressure to the slurry and atomizing the slurry with gas, i.e., atomization gas (carrier gas), and is used as a method for converting the slurry into droplets.

It should be noted that the nozzle mechanism is not limited to the above-described two-fluid nozzle mechanism but a single-fluid nozzle mechanism may also be used. Other exemplary methods include a method which involves causing a slurry to fall at a constant speed onto a rotating disk so as to convert the slurry into droplets (to form droplets) by the centrifugal force, and a method which involves applying a high voltage to the surface of a slurry to convert the slurry into droplets (to form droplets).

The chamber 16 is provided below and adjacent to the plasma torch 12. The copper compound powder and the alkaline earth metal compound powder supplied into the thermal plasma flame 24 in the plasma torch 12 are evaporated into a gas phase state, and the copper compound and the alkaline earth metal compound react with each other to form metal complex oxide fine particles. Then, the fine particles are quenched by cooling gas in the chamber 16 to produce primary fine particles 15 (metal complex oxide fine particles). The chamber 16 also serves as a cooling tank.

A gas supply device 28 is connected to the chamber 16 through pipe 28a. The gas supply device 28 includes a gas supply section (not shown) storing cooling gas to be supplied into the chamber 16, a compressor applying push-out pressure to the cooling gas supplied from the gas supply section, and a pressure application means such as a blower (not shown). The gas supply device 28 is also provided with a pressure control valve 28b which controls the amount of gas supplied from the gas supply section.

As with the above-described plasma gas, for example, an inert gas is used as the cooling gas. The gas supply section stores, for example, nitrogen gas.

The gas supply device 28 supplies, for example, nitrogen gas as the cooling gas at a predetermined angle, for example, in a direction of arrow Q toward a tail portion of the thermal plasma flame 24, that is, toward an end of the thermal plasma flame 24 (an end portion of the thermal plasma flame 24) on the opposite side from the plasma gas supply port 12c, and also supplies the cooling gas from above to below along a side wall of the chamber 16, that is, in a direction of arrow R shown in FIG. 1. The flow rate of the cooling gas can be controlled with a float type flowmeter. The flow rate value of the cooling gas indicates a reading on the flowmeter.

In addition to the effect of quenching the metal complex oxide fine particles produced in the chamber 16 to form the primary fine particles 15 as described above, the cooling gas supplied from the gas supply device 28 has additional effects including contribution to the classification of the primary fine particles 15 in the cyclone 19.

In the case of the material supply device 14 which supplies in the form of powder, the copper compound powder and the alkaline earth metal compound powder supplied from the material supply device 14 into the plasma torch 12 together with carrier gas are converted into a gas phase state in the thermal plasma flame 24. Owing to quenching by nitrogen gas supplied from the gas supply device 28 toward the thermal plasma flame 24 in the direction of the arrow Q, the primary fine particles 15 of metal complex oxide fine particles are produced. In this process, nitrogen gas supplied in the direction of the arrow R prevents the primary fine particles 15 from adhering to the inner wall of the chamber 16, whereby the yield of the produced primary fine particles 15 is improved.

Under these circumstances, the cooling gas needs to be supplied in an amount sufficient to quench the resulting metal complex oxide fine particles in the process of producing the primary fine particles 15 of the metal complex oxide fine particles and is preferably supplied in such an amount that the flow rate enabling classification of the primary fine particles 15 at any classification point in the downstream cyclone 19 is obtained and that stabilization of the thermal plasma flame 24 is not hindered. The supply method, supply position and the like of the cooling gas are not particularly limited as long as the stabilization of the thermal plasma flame 24 is not hindered. In the fine particle production apparatus 10 in the embodiment, a circumferential slit is formed in a top plate 17 to supply the cooling gas but any other method or position may be applied as long as the method or position applied enables reliable supply of gas on the path from the thermal plasma flame 24 to the cyclone 19.

The total amount of the nitrogen gas supplied in the direction of the arrow Q and the nitrogen gas supplied in the direction of the arrow R should be set to 200 vol % to 5,000 vol % of the gas supplied into the thermal plasma flame 24. The gas supplied into the thermal plasma flame 24 mentioned above refers to the whole of plasma gas for forming the thermal plasma flame 24, central gas for forming a plasma flow and atomization gas.

In the case of the material supply device 14 which supplies in the form of slurry, a slurry in the form of droplets which contains the copper compound powder and the alkaline earth metal compound powder and has been supplied from the material supply device 14 into the plasma torch 12 using atomization gas at a predetermined flow rate is converted into a gas phase state by the thermal plasma flame 24, and the copper compound and the alkaline earth metal compound react with each other to form metal complex oxide fine particles. The metal complex oxide fine particles formed from the copper compound powder and the alkaline earth metal compound powder are also quenched in the chamber 16 by cooling gas supplied toward the thermal plasma flame 24 in the direction of the arrow Q to produce the primary fine particles 15 of the metal complex oxide fine particles. In this process, argon gas supplied in the direction of the arrow R prevents the primary fine particles 15 from adhering to the inner wall of the chamber 16. As with the case described above, the yield of the produced primary fine particles 15 is improved owing to the argon gas supplied in the direction of the arrow R.

As shown in FIG. 1, the cyclone 19 for classifying the produced primary fine particles 15 based on a desired particle size is provided on a lower lateral side of the chamber 16. The cyclone 19 includes an inlet tube 19a which supplies the primary fine particles 15 from the chamber 16, a cylindrical outer casing 19b connected to the inlet tube 19a and positioned in an upper portion of the cyclone 19, a truncated conical part 19c continuing downward from a lower portion of the outer casing 19b and having a gradually decreasing diameter, a coarse particle collecting chamber 19d connected to a lower side of the truncated conical part 19c for collecting coarse particles having a particle size equal to or larger than the above-mentioned desired particle size, and an inner tube 19e connected to the collecting section 20 to be described later in detail and projecting from the outer casing 19b.

A gas stream containing the primary fine particles 15 produced in the chamber 16 is blown into the cyclone 19 from the inlet tube 19a thereof along the inner peripheral wall of the outer casing 19b, and this gas stream flows in the direction from the inner peripheral wall of the outer casing 19b to the truncated conical part 19c as indicated by arrow T in FIG. 1, thereby forming a downward swirling stream.

When the above-described downward swirling stream is inverted to form an upward stream, coarse particles cannot follow the upward stream due to the balance between the centrifugal force and drag but come down along the side surface of the truncated conical part 19c and are collected in the coarse particle collecting chamber 19d. Fine particles which were influenced by the drag more than the centrifugal force are discharged to the outside of the system from the inner tube 19e along with the upward stream on the inner wall of the truncated conical part 19c.

The apparatus is configured such that a negative pressure (suction force) is generated by the collecting section 20 as will be described in detail below and applied through the inner tube 19e. The apparatus is also configured such that, under the negative pressure (suction force), the metal complex oxide fine particles separated from the above-mentioned swirling gas stream are sucked as indicated by arrow U and sent to the collecting section 20 through the inner tube 19e.

On the extension of the inner tube 19e, which is an outlet for the gas stream in the cyclone 19, the collecting section 20 for collecting the secondary fine particles 18 of the metal complex oxide fine particles having a desired particle size on the order of nanometers is provided. The collecting section 20 includes a collecting chamber 20a, a filter 20b provided in the collecting chamber 20a, and a vacuum pump (not shown) connected through a pipe provided below inside the collecting chamber 20a. The fine particles delivered from the cyclone 19 are sucked by the vacuum pump (not shown) to be introduced into the collecting chamber 20a, and remain on the surface of the filter 20b and are then collected.

The method of producing metal complex oxide fine particles using the above-described production apparatus 10 and metal complex oxide fine particles produced by the production method are described below.

In this embodiment, for supplying materials, use may be made of, for example, two systems including one which supplies copper compound powder and alkaline earth metal compound powder in the form of powder and the other which supplies copper compound powder and alkaline earth metal compound powder in the form of slurry. Methods of producing metal complex oxide fine particles according to the respective material supply systems are now described.

First of all, in the case of supply in the form of powder, copper compound powder having average particle size of, for example, up to 5 μm and alkaline earth metal compound powder are charged into the material supply device 14 at a weight ratio of 5:5.

For example, argon gas and nitrogen gas are used as the plasma gas, and a high frequency voltage is applied to the coil 12b for high frequency oscillation to generate a thermal plasma flame 24 in the plasma torch 12.

Nitrogen gas is supplied in the direction of the arrow Q from the gas supply device 28 to the tail portion of the thermal plasma flame 24, i.e., to the end portion of the thermal plasma flame 24. At that time, the nitrogen gas is also supplied in the direction of the arrow R.

Next, the copper compound powder and the alkaline earth metal compound powder are transported with gas, for example, argon gas used as the carrier gas to be supplied into the thermal plasma flame 24 in the plasma torch 12 through the supply tube 14a. The copper compound powder and the alkaline earth metal compound powder are evaporated to be converted into a gas phase state in the thermal plasma flame 24, and the copper compound and the alkaline earth metal compound react with each other to form metal complex oxide fine particles. Then, the metal complex oxide fine particles are quenched by cooling gas, namely, nitrogen gas in the chamber 16 to thereby produce primary fine particles 15 of the metal complex oxide fine particles.

The primary fine particles 15 of the metal complex oxide fine particles as produced in the chamber 16 are blown through the inlet tube 19a of the cyclone 19 together with a gas stream along the inner peripheral wall of the outer casing 19b, and this gas stream flows along the inner peripheral wall of the outer casing 19b as indicated by the arrow T in FIG. 1, thereby forming a swirling stream, which goes downward. When the above-described downward swirling stream is inverted to form an upward stream, coarse particles cannot follow the upward stream due to the balance between the centrifugal force and drag but come down along the side surface of the truncated conical part 19c and are collected in the coarse particle collecting chamber 19d. Fine particles which were influenced by the drag more than the centrifugal force are discharged to the outside of the system from the inner tube 19e along with the upward stream on the inner wall of the truncated conical part 19c.

Under the negative pressure (suction force) from the collecting section 20, the discharged secondary fine particles 18 of the metal complex oxide fine particles are sucked in the direction indicated by the arrow U in FIG. 1 and delivered to the collecting section 20 through the inner tube 19e to be collected on the filter 20b of the collecting section 20. The internal pressure of the cyclone 19 at that time is preferably up to atmospheric pressure. For the particle size of the secondary fine particles 18 of the metal complex oxide fine particles, an arbitrary particle size on the order of nanometers is selected according to the intended purpose.

In this embodiment, the particulate metal complex oxide fine particles on the order of nanometers having transparency can be thus obtained easily and reliably by merely subjecting the copper compound powder and the alkaline earth metal compound powder to plasma treatment.

As the metal complex oxide fine particles, for instance, SrCu₂O₂ particles and BaCu₂O₂ particles can be produced. These are so-called p-type transparent oxide semiconductors which are p-type semiconductors and have a high transmittance and transparency. Thus, particulate p-type transparent oxide semiconductor particles having transparency can be obtained.

The expression “having transparency” in the present invention refers to the average transmittance in a visible light region with wavelengths of 350 to 700 nm being higher than that in an ultraviolet region with wavelengths of more than 300 nm but less than 350 nm. In p-type inorganic oxide semiconductors CuO, NiO and CoO as described in Patent Literature 1, the average transmittance in a visible light region is substantially the same as, in other words, is not higher than that in an ultraviolet region.

The metal complex oxide fine particles produced by the method of producing metal complex oxide fine particles according to the embodiment have a narrow particle size distribution, in other words, have a uniform particle size, and coarse particles having a particle size of 1 μm or more are hardly included. More specifically, the metal complex oxide fine particles have an average particle size on the order of nanometers ranging from about 1 to 100 nm.

Next, the case of supply in the form of slurry is described.

In this case, use is made of, for example, copper compound powder having an average particle size of up to 5 μm, alkaline earth metal compound powder and, for example, water as the dispersion medium. The mixing ratio of the mixture of copper compound powder and alkaline earth metal compound powder to water is adjusted to 5:5 (50%:50%) in terms of weight ratio to prepare a slurry.

The slurry is introduced into the vessel (not shown) of the material supply device 14 shown in FIG. 1 and agitated by the agitator (not shown). The copper compound powder and the alkaline earth metal compound powder in water are thus prevented from precipitating, whereby the slurry containing the copper compound powder and the alkaline earth metal compound powder dispersed in water is maintained. The slurry may be continuously prepared by supplying the copper compound powder, the alkaline earth metal compound powder and water to the material supply device 14.

Next, the above-described two-fluid nozzle mechanism (not shown) is used to convert the slurry into droplets, and the slurry in the form of droplets is supplied into the thermal plasma flame 24 generated in the plasma torch 12 using atomization gas at a predetermined flow rate. A slurry in the form of droplets which contains the copper compound powder and the alkaline earth metal compound powder is converted into a gas phase state by the thermal plasma flame 24, and the copper compound and the alkaline earth metal compound react with each other to form metal complex oxide fine particles. At that time, the metal complex oxide fine particles produced from the copper compound powder and the alkaline earth metal compound powder are quenched by nitrogen gas supplied in the direction of the arrow Q and thus quenched in the chamber 16, thereby obtaining primary fine particles 15.

The ambient pressure inside the plasma torch 12 is preferably up to atmospheric pressure. The ambient pressure of up to atmospheric pressure is not particularly limited and is, for example, in a range of 660 Pa to 100 kPa.

The primary fine particles 15 of the metal complex oxide fine particles finally produced in the chamber 16 are subjected to the same process as that performed on the primary fine particles prepared from materials in the form of powder as described above.

Similarly to the above-described fine particles prepared in the form of powder, under the negative pressure (suction force) from the collecting section 20, the discharged secondary fine particles 18 of the metal complex oxide fine particles are sucked in the direction indicated by the arrow U and delivered to the collecting section 20 through the inner tube 19e to be collected on the filter 20b of the collecting section 20. The internal pressure of the cyclone 19 at that time is preferably up to atmospheric pressure. For the particle size of the secondary fine particles 18 of the metal complex oxide fine particles, an arbitrary particle size on the order of nanometers is defined according to the intended purpose.

Also in the form of slurry, the particulate metal complex oxide fine particles, i.e., particulate p-type transparent oxide semiconductor particles on the order of nanometers having transparency can be obtained easily and reliably merely through plasma treatment as in the form of powder.

It should be noted that the number of cyclones used in the method of producing metal complex oxide fine particles according to the invention is not limited to one but may be two or more.

Fine particles just after the production collide with each other to form agglomerates, thereby causing unevenness in particle size, which may reduce the quality. However, dilution of the primary fine particles 15 with cooling gas supplied in the direction of the arrow Q toward the tail portion (end portion) of the thermal plasma flame 24 prevents the fine particles from colliding with each other to agglomerate together.

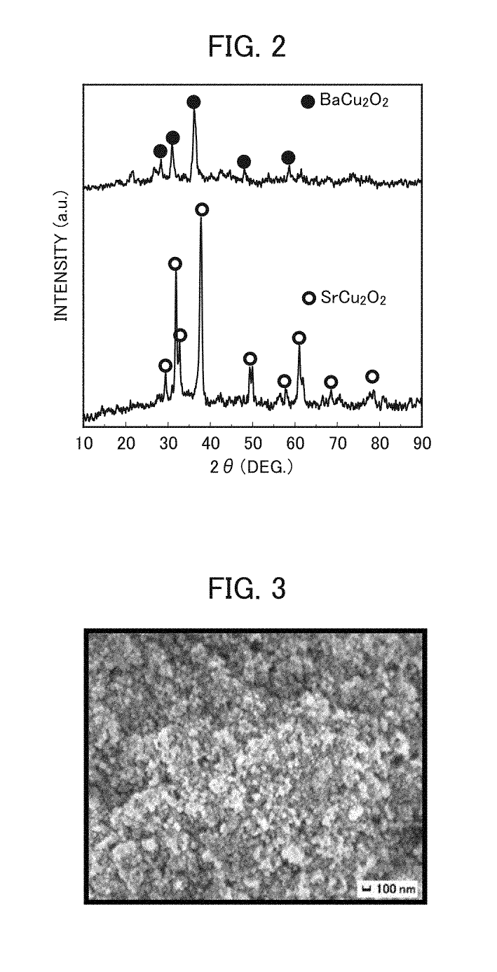

Meanwhile, the present inventor has used powder of cupric oxide (CuO) as the copper compound powder, powder of strontium carbonate (SrCO₃) as the compound powder, and argon gas and nitrogen gas as the plasma gas. It was confirmed that an SrCu₂O₂ single phase is obtained as metal complex oxide fine particles having transparency by supplying the cupric oxide (CuO) powder and the strontium carbonate (SrCO₃) powder to a thermal plasma flame, as shown in FIG. 2. Aside from that, it was confirmed that a BaCu₂O₂ single phase is obtained as metal complex oxide fine particles by supplying the cupric oxide (CuO) powder and barium carbonate (BaCO₃) powder to the thermal plasma flame 24 using argon gas and nitrogen gas, as shown in FIG. 2. In this case, for the structure, a particulate structure is obtained as shown in FIG. 3.

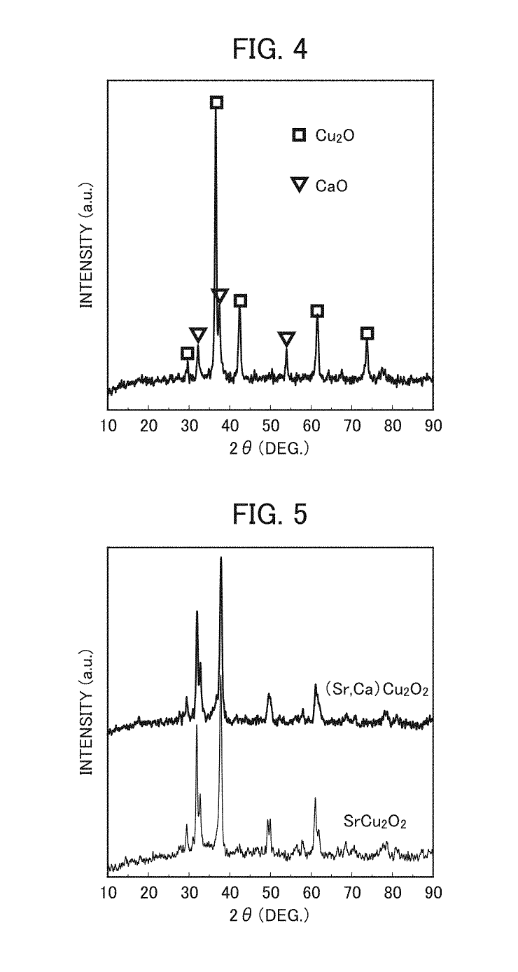

On the other hand, it was confirmed that when the cupric oxide (CuO) powder and calcium carbonate (CaCO₃) powder are supplied to the thermal plasma flame using argon gas and nitrogen gas as the plasma gas, a mixed phase of Cu₂O (cuprous oxide) and CaO (calcium oxide) is obtained as shown in FIG. 4, and metal complex oxide fine particles cannot be obtained. Thus, the combination of the copper compound and the alkaline earth metal compound containing, of Sr and Ba, at least one alkaline earth metal according to the invention is indispensable to obtain the metal complex oxide fine particles of the invention.

The present inventor also confirmed that an (Sr, Ca)Cu₂O₂ phase is obtained as metal complex oxide fine particles having transparency by supplying the cupric oxide (CuO) powder, the strontium carbonate (SrCO₃) powder and the calcium carbonate (CaCO₃) powder to the thermal plasma flame using argon gas and nitrogen gas as the plasma gas, as shown in FIG. 5. For the purpose of comparison, an analysis result of SrCu₂O₂ as obtained by X-ray diffractometry is also shown in FIG. 5.

As shown in FIG. 5, even when the calcium carbonate (CaCO₃) powder is added to the cupric oxide (CuO) powder and the strontium carbonate (SrCO₃) powder, an SrCu₂O₂ phase can be obtained.

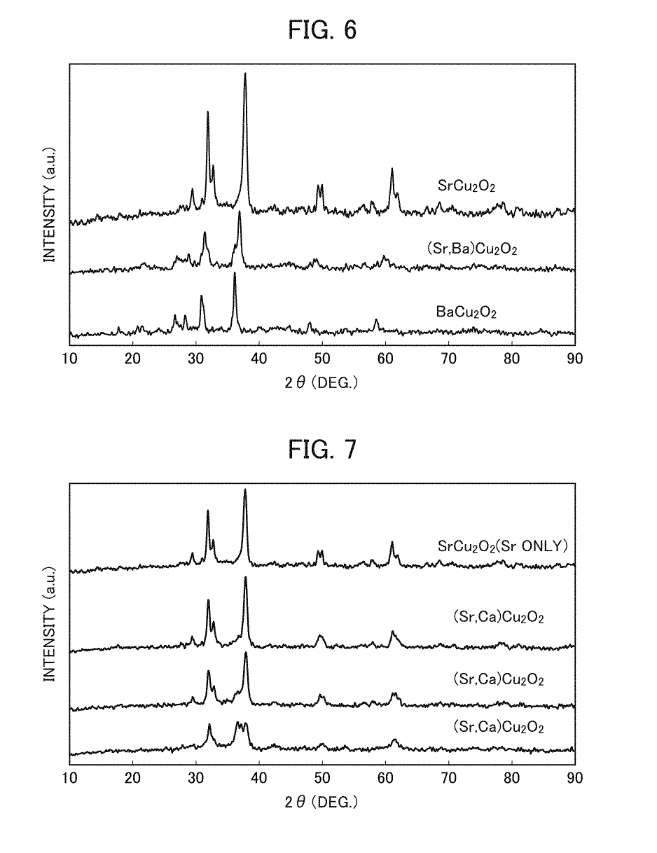

The present inventor also confirmed that an (Sr, Ba)Cu₂O₂ phase is obtained as metal complex oxide fine particles by supplying the cupric oxide (CuO) powder, the strontium carbonate (SrCO₃) powder and barium carbonate (BaCO₃) powder to the thermal plasma flame using argon gas and nitrogen gas as the plasma gas, as shown in FIG. 6. For the purpose of comparison, analysis results of BaCu₂O₂ and SrCu₂O₂ as obtained by X-ray diffractometry are also shown in FIG. 6.

As shown in FIG. 6, the metal complex oxide fine particles with the composition in which strontium and barium are complexed can be formed.

The present inventor also confirmed that an (Sr, Ca)Cu₂O₂ phase is obtained as metal complex oxide fine particles by supplying the cupric oxide (CuO) powder, the strontium carbonate (SrCO₃) powder and calcium carbonate (CaCO₃) powder to the thermal plasma flame using argon gas and nitrogen gas as the plasma gas, as shown in FIG. 7. In FIG. 7, results of plural (Sr, Ca)Cu₂O₂ phases are shown because different ratios between strontium and calcium were employed. For the purpose of comparison, an analysis result of SrCu₂O₂ as obtained by X-ray diffractometry is also shown in FIG. 7.

As shown in FIG. 7, the metal complex oxide fine particles with the composition in which strontium and calcium are complexed can be formed, and furthermore, the metal complex oxide fine particles can be formed even with a varied ratio between strontium and calcium.

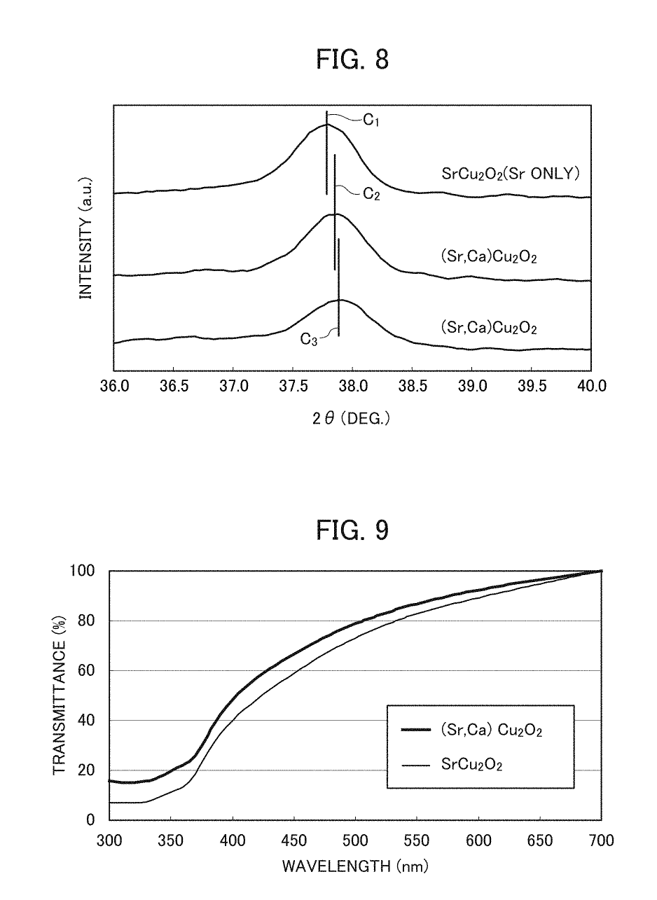

FIG. 8 is an enlarged view showing a main part of FIG. 7. In FIG. 8, C₁ indicates a peak position of SrCu₂O₂, C₂ indicates a peak position of (Sr, Ca)Cu₂O₂ in which, of Sr and Ca, Sr is present more than Ca, and C₃ indicates a peak position of (Sr, Ca)Cu₂O₂ in which, of Sr and Ca, Sr is present more than Ca with the proportion of Ca being higher than that in the case of C₂. As can be seen from FIG. 8, a peak position is shifted to a larger angle side with a higher proportion of calcium.

The metal complex oxide fine particles with the composition of SrCu₂O₂ and the metal complex oxide fine particles with the composition of (Sr, Ca)Cu₂O₂ at a molar ratio of Sr:Ca of 7:3 were each dispersed in an ethanol solvent using ultrasonic waves to measure the transmittance as the optical characteristics. The results are shown in FIG. 9. The transmittance was measured with a spectrophotometer.

As shown in FIG. 9, the transmittance was able to be measured for both the metal complex oxide fine particles obtained from strontium and a copper oxide and the metal complex oxide fine particles obtained from strontium, calcium, with a molar ratio of Sr:Ca of 7:3, and a copper oxide. This means that particles were dispersed in the ethanol solvent.

In addition, adding calcium to strontium results in an improved transmittance. In other words, the transparency is increased. Thus, the optical characteristics can be changed by changing the composition of metal complex oxide fine particles.

Also in the example shown in FIG. 9, the average transmittances of the metal complex oxide fine particles with the composition of (Sr, Ca)Cu₂O₂ and the metal complex oxide fine particles with the composition of SrCu₂O₂ in a visible light region are both higher than those in an ultraviolet region. It is apparent from this fact that the metal complex oxide fine particles with the composition of (Sr, Ca)Cu₂O₂ and the metal complex oxide fine particles with the composition of SrCu₂O₂ have transparency.

The present invention is basically configured as above. While the metal complex oxide fine particles and the method of producing the same according to the invention have been described above in detail, the invention is by no means limited to the foregoing embodiments and it should be understood that various improvements and modifications are possible without departing from the scope and spirit of the invention.

### REFERENCE SIGNS LIST

10 fine particle production apparatus

12 plasma torch

14 material supply device

15 primary fine particle

16 chamber

18 fine particle (secondary fine particle)

19 cyclone

20 collecting section

22 plasma gas supply device

24 thermal plasma flame

28 gas supply device

1-9. (canceled)

10. A metal complex oxide fine particles containing copper as represented by a general formula MCu2O2,
wherein M in the general formula is, of Sr and Ba, at least one alkaline earth metal,
the metal complex oxide fine particles having a particle size of 1 to 100 nm and having transparency.

11. The metal complex oxide fine particles according to claim 10, wherein M in the general formula further includes, of Mg and Ca, at least one Group 2 element.

12. A method of producing metal complex oxide fine particles, comprising:
a pretreatment step of pretreating copper compound powder and alkaline earth metal compound powder containing, of Sr and Ba, at least one alkaline earth metal; and
a formation step of forming particulate metal complex oxide fine particles having transparency from the copper compound powder and alkaline earth metal compound powder as pretreated, using a thermal plasma flame,
wherein the thermal plasma flame is derived from an inert gas.

13. The method of producing metal complex oxide fine particles according to claim 12,
wherein the pretreatment step includes a step of dispersing the copper compound powder and the alkaline earth metal compound powder using a carrier gas, and
wherein the formation step includes a step of supplying the copper compound powder and the alkaline earth metal compound powder as dispersed, into the thermal plasma flame.

14. The method of producing metal complex oxide fine particles according to claim 12,
wherein the pretreatment step includes a step of dispersing the copper compound powder and the alkaline earth metal compound powder in water to obtain a slurry, and
wherein the formation step includes a step of converting the slurry into droplets to supply the droplets into the thermal plasma flame.

15. The method of producing metal complex oxide fine particles according to claim 12, wherein the copper compound powder is cupric oxide powder.

16. The method of producing metal complex oxide fine particles according to claim 13, wherein the copper compound powder is cupric oxide powder.

17. The method of producing metal complex oxide fine particles according to claim 14, wherein the copper compound powder is cupric oxide powder.

18. The method of producing metal complex oxide fine particles according to claim 12, wherein the formation step further includes a step of supplying a cooling gas to an end portion of the thermal plasma flame.

19. The method of producing metal complex oxide fine particles according to claim 13, wherein the formation step further includes a step of supplying a cooling gas to an end portion of the thermal plasma flame.

20. The method of producing metal complex oxide fine particles according to claim 14, wherein the formation step further includes a step of supplying a cooling gas to an end portion of the thermal plasma flame.

21. The method of producing metal complex oxide fine particles according to claim 15, wherein the formation step further includes a step of supplying a cooling gas to an end portion of the thermal plasma flame.

22. The method of producing metal complex oxide fine particles according to claim 12, wherein the inert gas is at least one selected from helium gas, argon gas and nitrogen gas.

23. The method of producing metal complex oxide fine particles according to claim 13, wherein the inert gas is at least one selected from helium gas, argon gas and nitrogen gas.

24. The method of producing metal complex oxide fine particles according to claim 14, wherein the inert gas is at least one selected from helium gas, argon gas and nitrogen gas.

25. The method of producing metal complex oxide fine particles according to claim 15, wherein the inert gas is at least one selected from helium gas, argon gas and nitrogen gas.

26. The method of producing metal complex oxide fine particles according to claim 12, wherein the alkaline earth metal compound powder further includes a compound containing, of Mg and Ca, at least one Group 2 element.

27. The method of producing metal complex oxide fine particles according to claim 13, wherein the alkaline earth metal compound powder further includes a compound containing, of Mg and Ca, at least one Group 2 element.

28. The method of producing metal complex oxide fine particles according to claim 14, wherein the alkaline earth metal compound powder further includes a compound containing, of Mg and Ca, at least one Group 2 element.

29. The method of producing metal complex oxide fine particles according to claim 15, wherein the alkaline earth metal compound powder further includes a compound containing, of Mg and Ca, at least one Group 2 element.
